(19) United States
(12) Patent Application Publication
(10) Pub. No.: US 2010/0153300 A1
(43) Pub. Date: Jun. 17, 2010

(54) DERIVATIVE TRADING STRATEGY BACKTESTING MACHINE

(75) Inventors: Anthony D. Kolton, Park Ridge, IL (US); Gene J. Koziarz, Chicago, IL (US); Peter Gibbons Burke, JR., Austin, TX (US); Stephen A. Longo, Dripping Springs, TX (US)

Correspondence Address: PERRY HOFFMAN & ASSOCIATES P.C., PO BOX 1649, DEERFIELD, IL, 60015, US

(73) Assignee: Logical Information Machines, Inc., Chicago, IL (US)

(21) Appl. No.: 12/485,149

(22) Filed: Jun. 16, 2009

Related U.S. Application Data
(60) Provisional application No. 61/079,825, filed on Jul. 11, 2008.

(51) Int. Cl. G06Q 40/00; G06F 3/048

(52) U.S. Cl. 705/36 R; 715/781

(57) ABSTRACT

An automated information search, retrieval and reporting system, and more particularly, a system designed for the historical backtesting of financial market positions, for example, the simulation of the execution of derivative trading strategies. A user accesses data in a market information database via user interface by submitting queries in a near natural language format that define a desired derivative trading strategy with respect to one or more tradable securities. Historical daily price information about securities and derivatives are gathered and combined in a single location. Derivative relative data is created from the historical information and stored as a continuous historical series, wherein the derivative relative data is derived from each derivative's relative position to the underlying instrument with respect to price and date information. Reports express the results of the simulated execution of the derivative trading strategy that would have resulted from actual execution of the derivative trading strategy in the historical timeframe, including the daily profits and losses.

### CROSS-REFERENCE TO RELATED APPLICATION

This application claims priority pursuant to 35 U.S.C. 119(e) to U.S. Provisional Application No. 61/079,825, filed on Jul. 11, 2008 which is incorporated herein by reference in its entirety.

### FIELD OF THE INVENTION

The present inventions relates generally to automated information search, retrieval and reporting systems, and more particularly, to systems designed for the historical backtesting of financial market positions, for example, simulating the execution of derivative trading strategies.

### BACKGROUND OF THE INVENTION

Traders, portfolio managers, investors, market analysts, and other market players commonly utilize historical data to analyze past market behavior and to predict future market behavior in a process known as backtesting. Database systems that aid in the use of backtesting are well known.

U.S. Pat. Nos. 5,414,838, 5,590,325 and 5,778,357, all of which are incorporated herein by reference in their entirety, disclose a system and method for querying commodity price (e.g. stock price) information databases. A user provides a query specifying trading date attributes, including calendar events, such as national holidays and triple-witching hours, and/or fundamental events such as dates of political elections, dates a particular stock had a closing price above or below a certain level, dates of company earnings reports, dates of release of economic information (e.g. consumer price index) and so on. The query can be provided in a near natural language format, and reports from the query can be viewed in either tabular or graphic form.

These types of backtesting products in the prior art have also been employed to simulate options contract trading. However, in the prior art, simulating options trading based on historical data can be cumbersome and time consuming for at least three reasons. First, options trading often involves complex strategies with multiple options and multiple underlying instruments. Second, the historical data needed to simulate such strategies often comes from multiple sources. And third, a great number of calculations are needed. This problem is further complicated because at any given time a particular stock, future, index, or other tradable commodity may have on the order of tens of options contracts relating to each.

Accordingly, it would be desirable to create a unified database containing historical options-related data for all underlying instruments wherein all necessary calculations are made before populating the database and wherein the database is capable of being updated daily based on the closing bid and asking price of each option. This can be accomplished by populating the database with daily greek values and other pertinent information as it relates to each options relative position to the underlying instrument with respect to the time to expiration and relative “moneyness”, the moneyness being the option's relative position in the money, out of the money, or at the money. In addition, all option greeks and market statistics are converted into continuous historical series. It is further desirable to have an ergonomic user interface that allows simulating complex options positions under multiple conditions with a specified exit strategy. Thus, a user may quickly and easily define a query and receive almost instantaneous results in reports showing profits and losses, transaction detail, and daily holdings, among other relevant information. The inventions discussed in connection with the described embodiment address these and other deficiencies of the prior art.

The features and advantages of the present inventions will be explained in or apparent from the following description of the preferred embodiment considered together with the accompanying drawings.

### SUMMARY OF THE INVENTION

The present inventions address the deficiencies of the prior art of computer-implemented derivative trading strategy backtesting machines by providing a market information database with historical daily information for securities and financial contracts whose values are derived from the value of the underlying security as well as derivative relative data created from said historical daily information stored as a continuous historical series. A user interface and reporting capabilities allow a user to search the database with near natural language queries and quickly produce reports showing historical daily market position information, including profits and losses. Thus, unlike the prior art, backtesting derivative trading strategies will no longer be cumbersome and time consuming.

More particularly, the present inventions include a market information database comprising of three datasets. The first dataset contains daily price information about tradable securities such as that disclosed in applicant assignee's U.S. Pat. Nos. 5,414,838, 5,590,325 and 5,778,357, which are incorporated by reference. The second dataset contains historical daily information for a plurality of derivatives of each underlying tradable security, wherein the derivatives are financial contracts, or financial instruments, whose values are derived from the value of something else, known as the underlying. The information in the second dataset is not known to exist in one location in the prior art. Also not known to exist in the prior art, the third dataset contains derivative relative data created from historical daily information for the securities and the derivatives and is stored as a continuous historical series, wherein the derivative relative dataset is derived from each derivative's relative position to the underlying with respect to price and date information.

The market information database further comprises, with respect to each tradable security, historical daily information about options corresponding to the tradable security including the option's strike price, expiration date, its daily position in or out of or at the money, known as moneyness, its closing bid and ask prices, and one or more of its daily greek values, including delta values. This information is used to populate the second and third datasets described above.

The described database may also further comprise a model based pricing dataset containing simulated historical information.

The present inventions utilize a user interface that facilitates gathering information from the user defining a desired derivative trading strategy with respect to one or more of the tradable securities. The user interface presents several window panes for creating and viewing user defined queries in an ORDER-WHEN-EXIT format. An enter and edit query pane allows the user to enter one or more trades directly, by selecting elements, or by a command line where the user can navigate between trades. An option order pane is used for entering the trade type, the contract quantity, the moneyness, a delta value, the month of the contract relative to the option's expiration, the option strategy, the option to order, the percentage of shares to cover, and the conditions under which to roll the trade. A hedge pane is used for setting conditions of the delta hedge based on time period and the value of a position. A roll-order-if pane is used for setting conditions under which to roll the order. A when pane is used for defining conditions under which the order should be executed. An exit pane is used for defining an exit strategy.

The user interface further comprises a report manipulation pane for manipulating the dates and price adjustment status of the data shown. A reporting engine is responsive to the user inputs from the report manipulation pane to generate user defined reports. The user may produce reports showing either five day series or seven day series, showing the derivative trading strategy position data for every day or only for days when data changes, showing overlapping time periods as the union of the two periods or as the intersection of the two periods, and showing pricing data that is backward adjusted or not.

As the user defines the desired trading strategy, a machine-parsable expression generator states the user's desired strategy and displays the strategy in the enter and edit query pane in the ORDER-WHEN-EXIT format. A parser then parses the machine-parsable expression into a sequence of commands to be processed. A processor then executes the commands in response to the parser to extract data from the market information database. A trading execution engine, in response to the processor, that receives data from the database, uses the data to compute the simulated trading position that would have resulted from actual execution of the derivative trading strategy in the historical timeframe. Finally, the reporting engine allows the user to visualize the results of the computations as reports that express the results of the simulated execution of the derivative trading strategy that would have resulted from actual execution of the derivative trading strategy in the historical timeframe, including the daily profits and losses.

### BRIEF DESCRIPTION OF THE DRAWINGS

The inventions will now be more particularly described by way of example with reference to the accompanying drawings. Novel features believed characteristic of the inventions are set forth in the claims. The inventions themselves, as well as the preferred mode of use, further objectives, and advantages thereof, are best understood by reference to the following detailed description of the embodiment in conjunction with the accompanying drawings, in which:

FIG. 1 shows a high level schematic diagram of the derivative trading strategy backtesting machine.

FIG. 2 shows the main screen of the graphical user interface.

FIG. 3 shows the option order pane of the main screen.

FIG. 4A shows the data browser for underlying stocks, exchange traded funds, and indices.

FIG. 4B shows search results for a particular stock, exchange traded fund, or index.

FIG. 4C shows the data browser for futures.

FIG. 5 shows the report manipulation pane.

FIG. 6A shows a report displaying overall transaction detail.

FIG. 6B shows a report displaying overall portfolio value.

FIG. 6C shows a report displaying transactions by labeled trade.

FIG. 6D shows a report displaying transaction detail by date.

### DETAILED DESCRIPTION OF THE EMBODIMENTS

The described embodiment is an options tester that offers the ability to backtest any combination of options trading strategies including straddles, strangles, vertical, ratio, calendar or any customized spread over time using historical end of day bid and ask price data for valuations. The user will be able to customize delta hedging strategies, use customizable rollover capabilities, perform customized spread and cross market option analysis, quantify realized and implied volatility changes, analyze changes in volume, open interest, volatility and greeks, stress test strategies using historical, fundamental and event driven analysis, build strategies based on an option's delta or percentage in or out of the money, and access al profits and losses and greeks from one report.

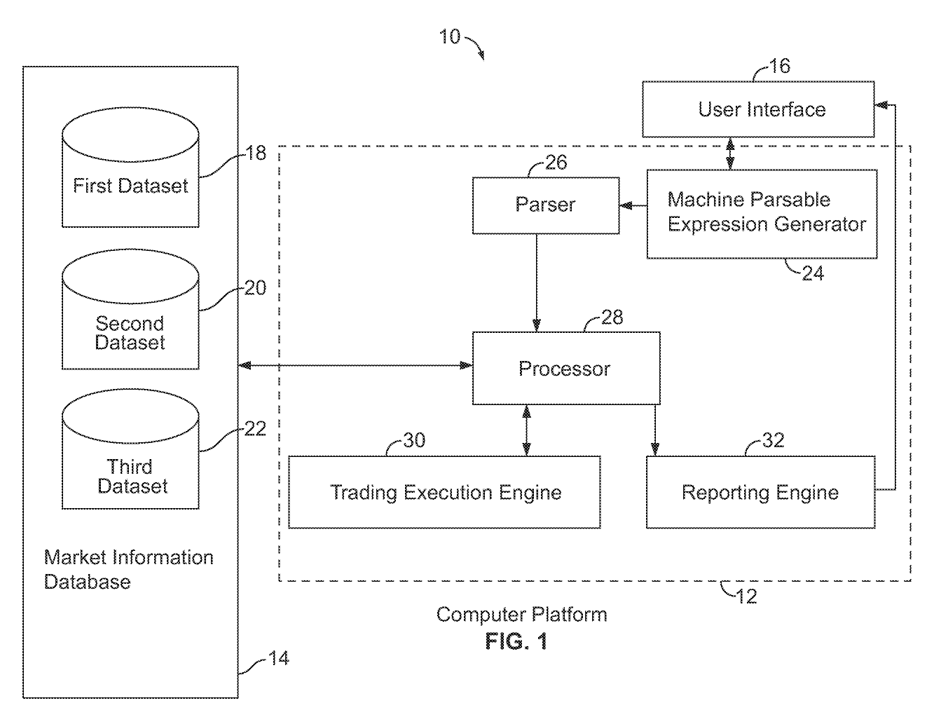

FIG. 1 shows a high level schematic diagram of the derivative trading strategy backtesting machine 10. The described embodiment is implemented on any professional workstation or stand alone computer platform. In FIG. 1, the backtesting machine 10 is shown to have three main components, the computer platform 12, the market information database 14, and the user interface 16.

A user accesses data in the market information database 14 via the user interface 16 by submitting queries in batch mode, by typing expressions directly, or by making selections in various window panes. The user interface facilitates gathering information from the user defining a desired derivative trading strategy with respect to one or more of the tradable securities. For queries made by selections, a machine parsable expression generator 24 is used to state precisely the user's desired derivative trading strategy. The machine parsable expression generator 24 generates a near natural language query and simultaneously echoes the query to the screen and outputs the query to a parser 26. The parser 26 parses the machine parsable expression into a sequence of commands and outputs those commands to a processor 28, which executes responsive to the parser 26 to extract data from the market information database 14. The processor 28 then interacts with a trading execution engine 30 that is responsive to the processor 28 that receives data from the database and computes the simulated trading position that would have resulted from actual execution of the derivative trading strategy in the historical timeframe. Finally, a reporting engine 32 allows the user to visualize the results of the computations as reports that express the results of the simulated execution of the derivative trading strategy that would have resulted from actual execution of the derivative trading strategy in the historical timeframe, including the daily profits and losses.

The market information database 14 comprises three datasets.

The first dataset 18 contains daily price information about tradable securities such as that disclosed in applicant assignee's U.S. Pat. Nos. 5,414,838, 5,590,325 and 5,778,357, which are incorporated by reference.

The second dataset 20 contains historical daily information for a plurality of derivatives of each underlying tradable security, wherein the derivatives are financial contracts, or financial instruments, whose values are derived from the value of something else, known as the underlying. In the described embodiment, the data for the first dataset 18 and the second dataset 20 is provided by Logical Information Machines, Inc. (www.lim.com), OptionMetrics, LLC (www.optionmetrics.com), and FT Interactive Data Corporation, Inc. (www.ftinteractivedata.com). OptionMetrics provides equity and index historical pricing and equity and index theoretical values, known as Greeks. FT Interactive Data provides futures options historical pricing. Logical Information Machines provides futures options greeks. Users of the described embodiment are required to have licenses with Logical Information Machines and FT Interactive Data, Logical Information Machines and OptionMetrics, or Logical Information Machines, FT Interactive Data, and OptionMetrics for data. This combination of data from various sources combined in a single dataset is not known to exist in the prior art.

A general example of the data structure in the second dataset 20 can be made with reference to a dataset record in the following format:

TopRelation:<path>:<Symbol>_Options:<contract_folder>:<specific contract>

A specific options contract can be referenced as follows:

TopRelation:Options:OptionMetrics:FuturesOptions:n:ng:NG_Options:Options11 9562_{—}2005_{—}04:OM.SECID_{—}119562_NG.DA_{—}20050416C005.0

This record represents data supplied by OptionMetrics and specifically refers to a natural gas futures options contract with an expiration date of Apr. 16, 2005. The column names within this particular data record are:

AdjustmentFactor

BidPrice

LastTradeDate

OfferPrice

OpenInterest

OptionID

SpecialSettlement

Volume

The actual column names differ for each type of derivative.

The third dataset 22 contains derivative relative data created from historical daily information for the securities and the derivatives and is stored as a continuous historical series, wherein the derivative relative dataset is derived from each derivative's relative position to the underlying with respect to price and date information. This dataset is not known to exist in the prior art.

As an example, records in the third dataset 22 contain, with respect to each tradable security, historical daily information about options corresponding to the tradable security including the option's strike price, expiration date, its daily position in or out of or at the money, known as moneyness, its closing bid and ask prices, and one or more of its daily greek values, including delta values. The records in the third dataset 22 will also contain an option relative dataset for creating continuous option contracts for historical reference by an option's position to the underlying by relative moneyness and by an option's relative term to expiration. Further, the records in the third dataset 22 will contain option greeks and market statistics converted into continuous historical series.

Continuing the example for options contracts, referencing a record for particular options from a particular day from the third dataset 22, is done in a manner similar to referencing a record in the second dataset 20. Each record for options in the third dataset 22 contains the following columns:

LastTradeDate

OptionDelta

OptionGamma

OptionTheta

OptionVega

ImpVol

BidPrice

OfferPrice

OpenInterest

Volume

Additionally, each of these columns will have a relative column to describe the option's relative moneyness and relative term to expiration. The relative columns may be referenced in the following manner:

<SOURCE>.<CALL/PUT>.<ITM/ATM_nnn_PROMPT_nnn_columnname>

where SOURCE represents the source of the data. CALL/PUT represents whether the option is a call or a put. ITM/ATM_nnn_PROMPT_nnn_columnname represents the options relative relationship to the underlying for each of the above-named columns. For example,

OM.CALL.ITM_{—}000_PROMPT_{—}000_ABOVECOLUMNNAME

represents option relative data created from data originally supplied by OptionMetrics for a call at the money with the nearest expiration date. Similarly,

OM.PUT.OTM_{—}003_PROMPT_{—}002_ABOVECOLUMNNAME

represents option relative data created from data originally supplied by OptionMetrics for a put that is third out of the money with the third expiration date from the transaction date. Thus, for the exchange traded fund IWM as the underlying, the following data will be used to produce the corresponding option relative records:

Date DtExpire ITM/OTM PriceUnder Strike C/P Bid Offer ImpVol Delta Gamma

20001018 20001118 0 ITM 93.06 90.00 call 5.62 6.25 0.3742 0.6615 0.0366

OM.IWM,OM.CALL.ITM_{—}000_PROMPT000_UnderlyingPrice,93.06

OM.IWM,OM.CALL.ITM_{—}000_PROMPT000_Strike,90.00

OM.IWM,OM.CALL.ITM_{—}000_PROMPT000_Bid,5.62

OM.IWM,OM.CALL.ITM_{—}000_PROMPT000_Offer,6.25

OM.IWM,OM.CALL.ITM_{—}000_PROMPT000_ImpVol,0.3742

OM.IWM,OM.CALL.ITM_{—}000_PROMPT000_Delta,0.6615

OM.IWM,OM.CALL.ITM_{—}000_PROMPT000_Gamma,0.0366

This shows the populated record in the third dataset 22 for an at the money IWM call on Oct. 18, 2000 with an expiration date of Nov. 18, 2000.

In the market information database 14, the first dataset 18, the second dataset 20, and the third dataset 22 may all be supplemented with simulated historical information.

In the described embodiment, queries are made to the market information database 14 using an ORDER-WHEN-EXIT formatted query that may be used programmatically in batch mode or through a GUI desktop application. The following is an example which illustrates buying 250 second month Goldman Sachs straddles and selling 500 Lehman Brothers second month straddles after Jan. 1, 2005, when the ratio of the GS and LEH implied volatility is below 0.8, exiting the strategy 21 days after entry:

```
1: OPTION_ORDER
      1.1: Buy 250 ATM prompt 1 Straddle of equity TICKER.GS.NYSE
      1.2: Sell 500 ATM prompt 1 Straddle of equity
      TICKER.LEH.NYSE
WHEN
      CALL.ITM_001_PROMPT_001_ImpVol of GS_OPTREL /
      CALL.ITM_001_PROMPT_001_ImpVol of LEH_OPTREL is
            less than 0.8
AND
      Date is after 1/1/2005
EXIT
      Date is 21 days after entry
```

Note that the WHEN condition may be assembled as a Boolean expression. Boolean expressions may also be used as part of the EXIT condition.

The following is the syntax outline for the ORDER-WHEN-EXIT order block. A query may have more than one order block. The [ ] indicate optional syntax. The { } indicate choose one parameter. The | is used to separate choices. All keywords are in bold.

```
options tester query ::=
      option order block [option order block ...]
option order block ::=
order number: OPTION ORDER
      option contract order [option contract order ...]
      [DELTA HEDGE WITH CLOSE [EVERY N {DAYS|WEEKS}]]
      [ROLL ORDER [IF roll conditions ]]
      WHEN
            MQL condition
      [EXIT exit date condition]
option contract order ::=
      order number.order sub number:
            {BUY|SELL} qty contract selection [PROMPT +N]
                  [ROLL N DAYS BEFORE EXPIRATION]
                  {CALL|PUT|vanilla spread} of
                        {INDEX|STOCK|ETF|FUTURE|EQUITY}
                        underlying
                  [COVER % number { SHARES | CONTRACTS }]
                  [ENTER ON {BID|ASK|MIDPOINT|CLOSE}]
                  [ROLL IF roll conditions]
contract selection ::=
      {
      N ITM|N OTM|N % ITM|N % OTM|
      ‘{‘ { nearest(delta(number))|
            ge(delta(number))|gt(delta(number))|
            le(delta(number))|lt(delta(number))
      ’}’ }
      }
roll conditions ::=
      ‘{‘ [ not ] roll condition expr ’}’ [ { and | or } roll conditions ]
roll condition expr ::= expr {ge|le|gt|lt|eq|ne|<|<=|>=|>|==|!=} expr
expr ::= powterm [‘**’ powterm];
powterm ::= factor [{‘*’|‘/’} powterm];
factor ::= term [{‘+’|‘−’} factor];
term ::= ‘(‘ expr ’)’ | number | order_property_function |
            calls(order property function) | puts(order property
            function)
number ::= {digit} [‘.’ {digit}][(‘e’|‘E’) [‘−’] {digit}];
digit ::= ‘0’|‘1’|‘2’|‘3’|‘4’|‘5’|‘6’|‘7’|‘8’|‘9’;
order_property_function ::= max(property) |
            min(property) | sum(property) |
            avg(property) | wavg(property)
property ::= {delta|gamma|vega|theta|rho|IV|premium|itm|otm|
            daysexp|column(MIM column)}
exit date condition ::= Date is N days after entry
midpoint ::=
      Where midpoint of option is Option's (Bid + Ask) / 2
      Where midpoint of underlying is underlying's (High + Low) / 2
underlying ::= {stock|etf|future|index} ticker
ticker ::= Feed ticker for equity, index or continuous future
qty ::= integer > 0
move ::= float
N ::= integer >= 0
vanilla spread ::=
      { “Straddle” | “Strangle” |
      “Bear Call Spread” | “Bull Call Spread” |
      “Bear Put Spread” | “Bull Put Spread” |
      “Call Calendar Spread” | “Put Calendar Spread” |
      “Synthetic Long” | “Synthetic Short” |
      “Butterfly” }
order number ::= integer > 0
MQL condition ::= MIM syntax for conditions from XMIM
```

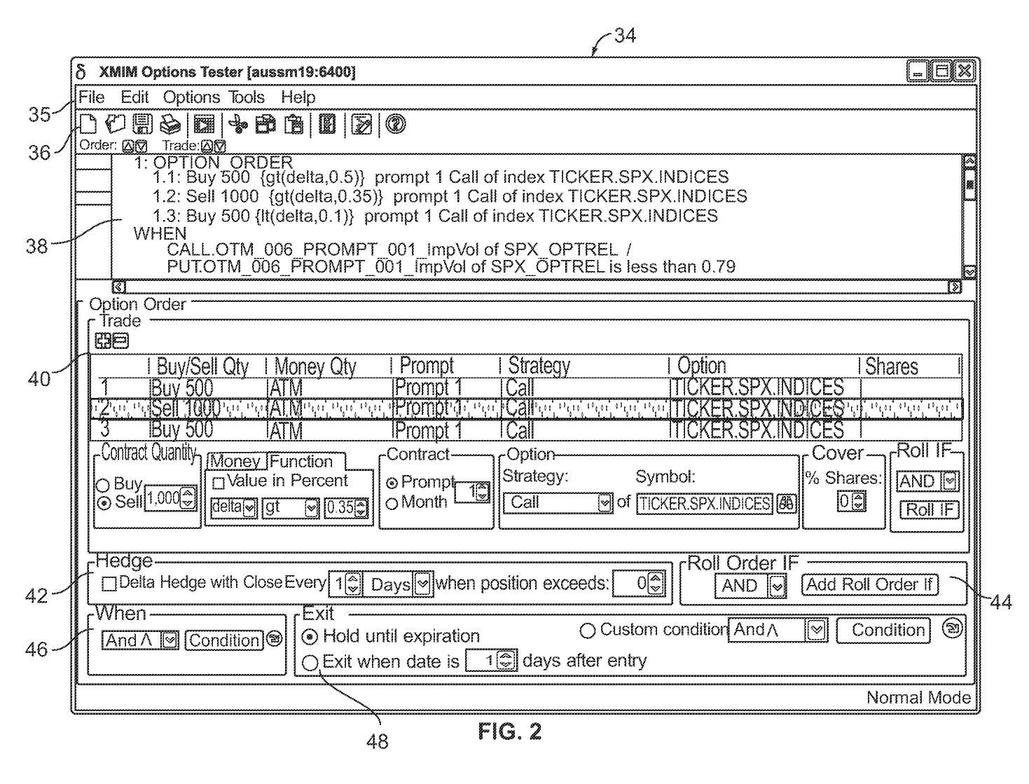

FIG. 2 shows the main screen of the graphical user interface 34. The menu bar 35 and the toolbar 36 of the graphical user interface 34 generally provide functions that are common to window-based interfaces. Additionally, the menu bar 35 and the toolbar 36 simplify the execution of certain commands that are unique to the described embodiment.

The user interface 34 further comprises several panes that are specific to the described embodiment. An enter and edit query pane 38 allows a user to enter one or more trades directly, by selecting elements, or by a command line where the user can navigate between trades. An option order pane 40 is used for entering the trade type, the contract quantity, the moneyness, a delta value, the month of the contract relative to the option's expiration, the option strategy, the option to order, the percentage of shares to cover, and the conditions under which to roll the trade. A hedge pane 42 is used for setting conditions of the delta hedge based on time period and value of position. A roll order if pane 44 is used for setting conditions under which to roll the option order. A when pane 46 is used for defining the conditions under which the option order should be executed. An exit pane 48 is used for defining the criteria under which to exit the option position.

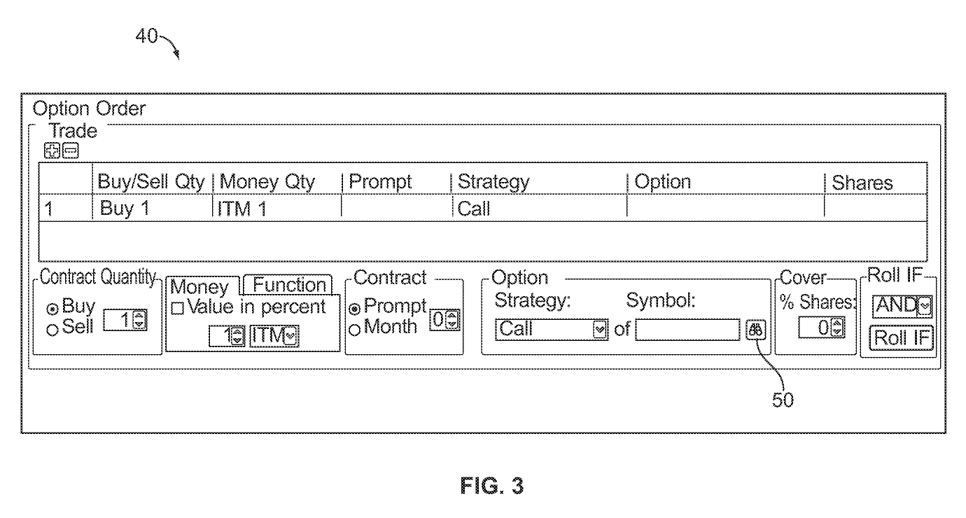

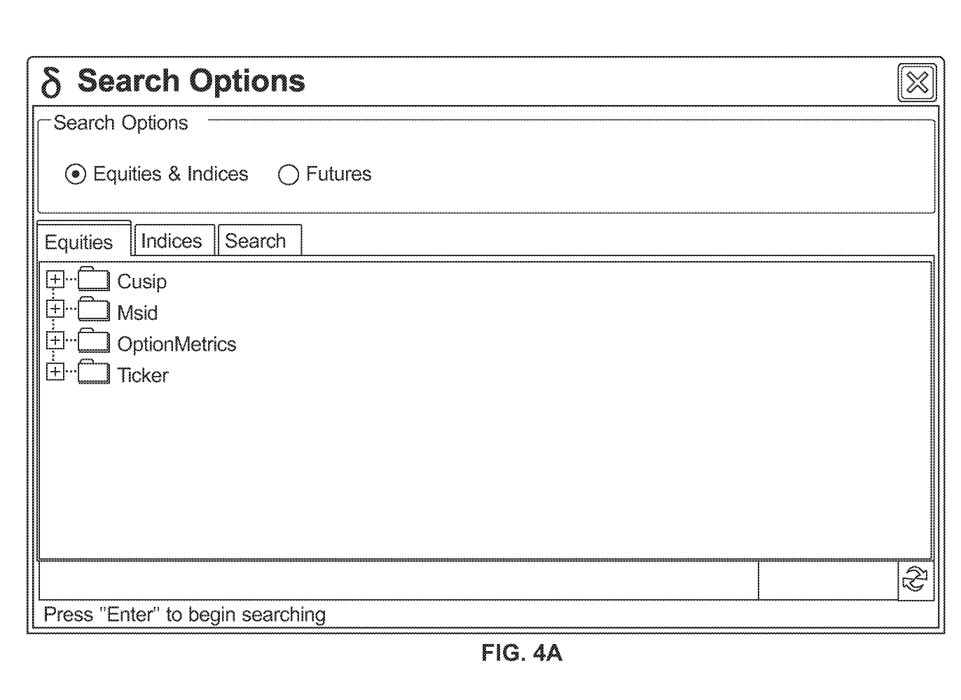

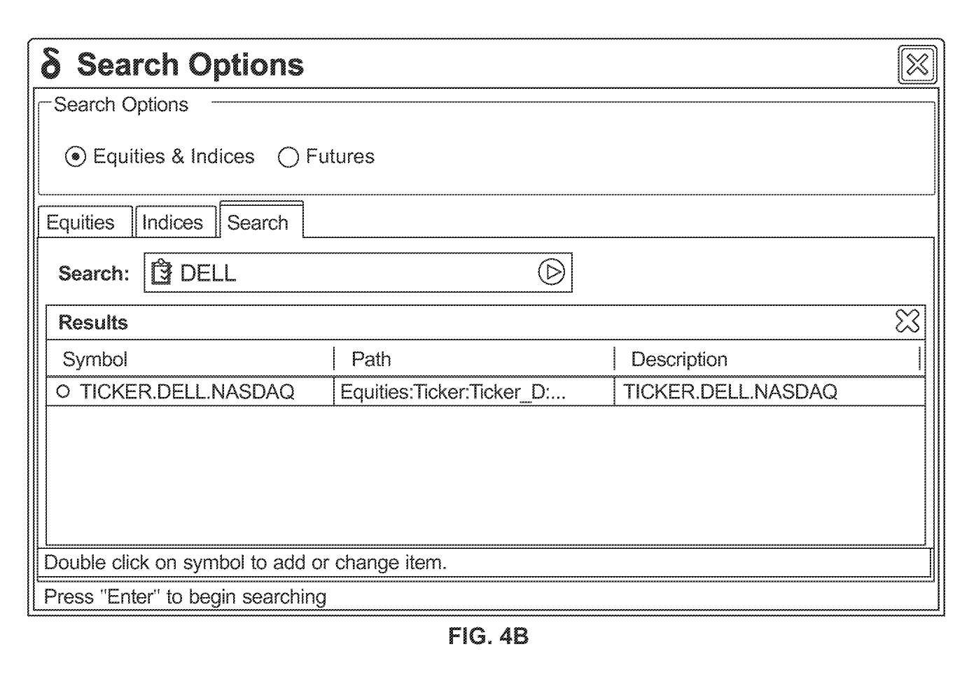

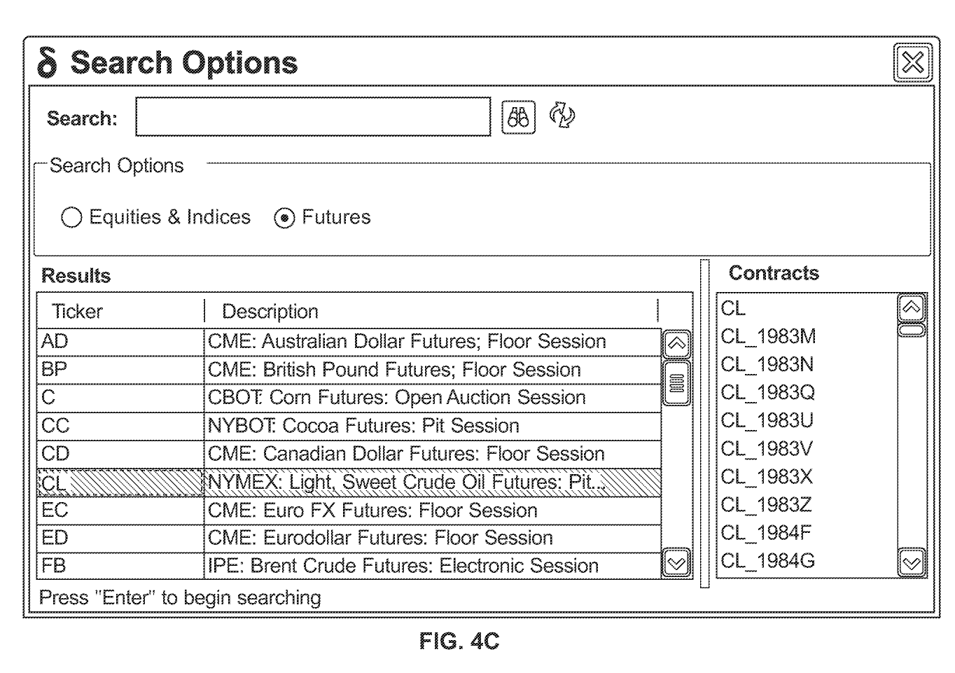

FIG. 3 shows the option order pane 40 of the main screen. By selecting the search button 50, the user may select the underlying stocks, exchange traded funds, indices, or futures. FIG. 4A shows the data browser for selecting underlying stocks, exchange traded funds, and indices. FIG. 4B shows search results for a particular stock, exchange traded fund or index, in this case the stock is for Dell Computers. FIG. 4C shows the data browser for futures.

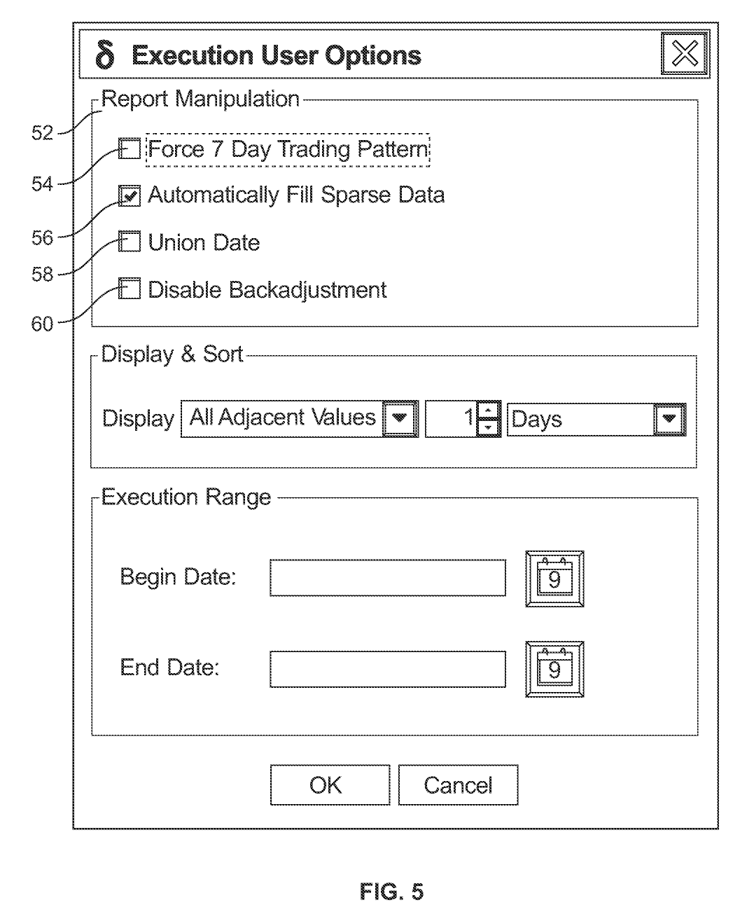

For generating reports, the user interface 16 also has a report manipulation pane 52 for manipulating the dates and price adjustment status of the data shown. FIG. 5 shows an Execution User Options window, which contains the report manipulation pane 52. The report manipulation pane 52 has four significant selection boxes. The force seven day trading pattern selection 54 is a user input for selecting whether the reporting engine will produce reports showing five day series or seven day series. The automatically fill sparse data selection 56 is a user input for selecting whether the reporting engine will produce reports showing derivative trading strategy position data for every day or only for days when data changes. The union date selection 58 is a user input for selecting whether the reporting engine will produce reports showing overlapping time periods as the union of the two periods or as the intersection of the two periods. The disable backadjustment selection 60 is a user input for selecting whether the reporting engine will produce reports showing backward adjusted pricing data. The Execution User Options window also has panes for selecting display and sort criteria as well as execution date range selections.

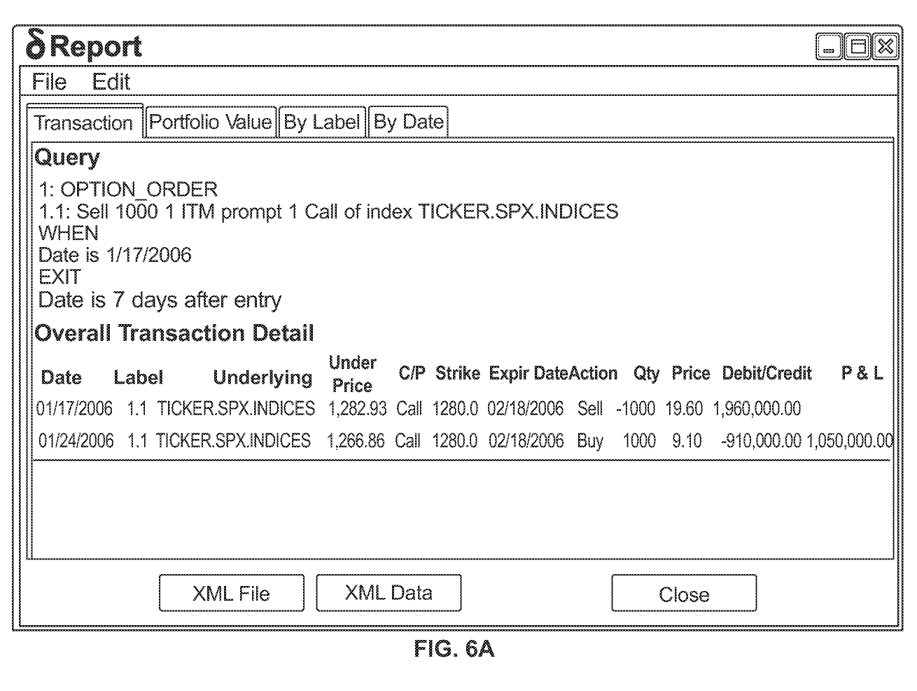

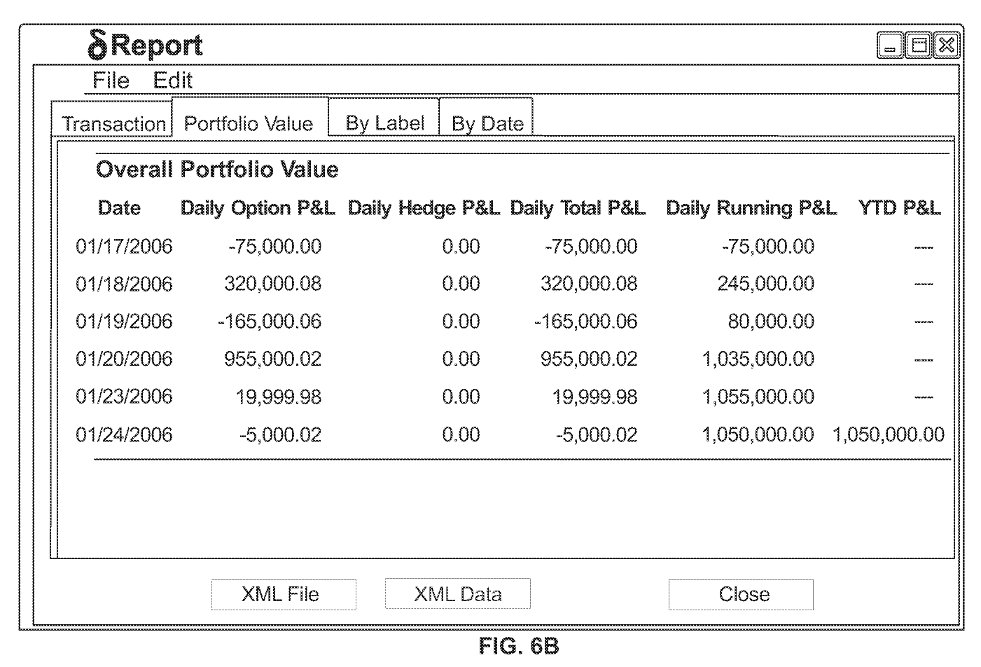

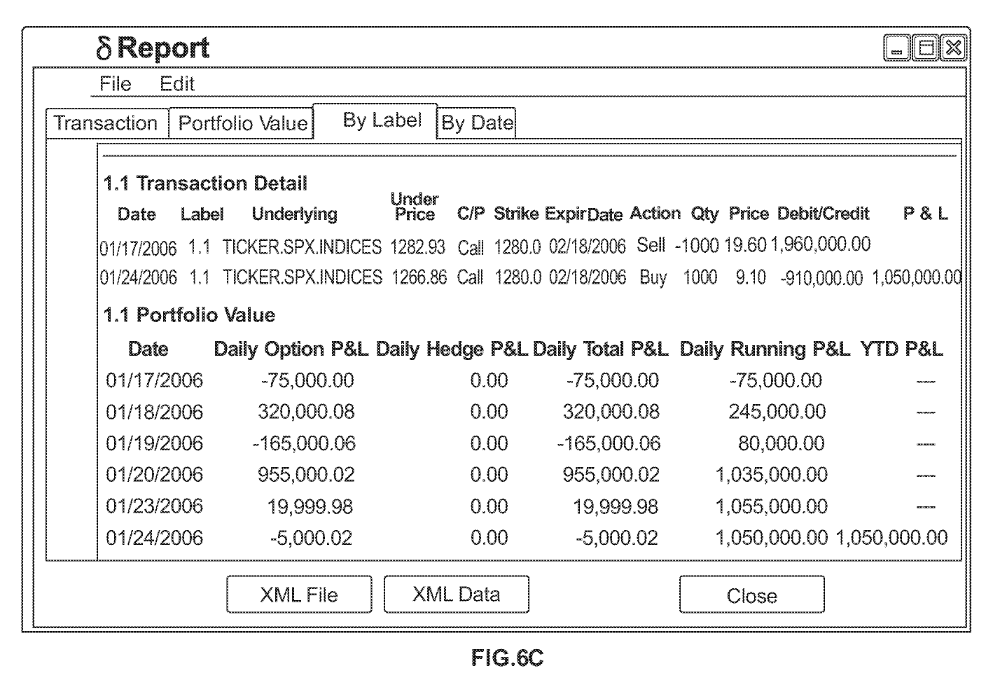

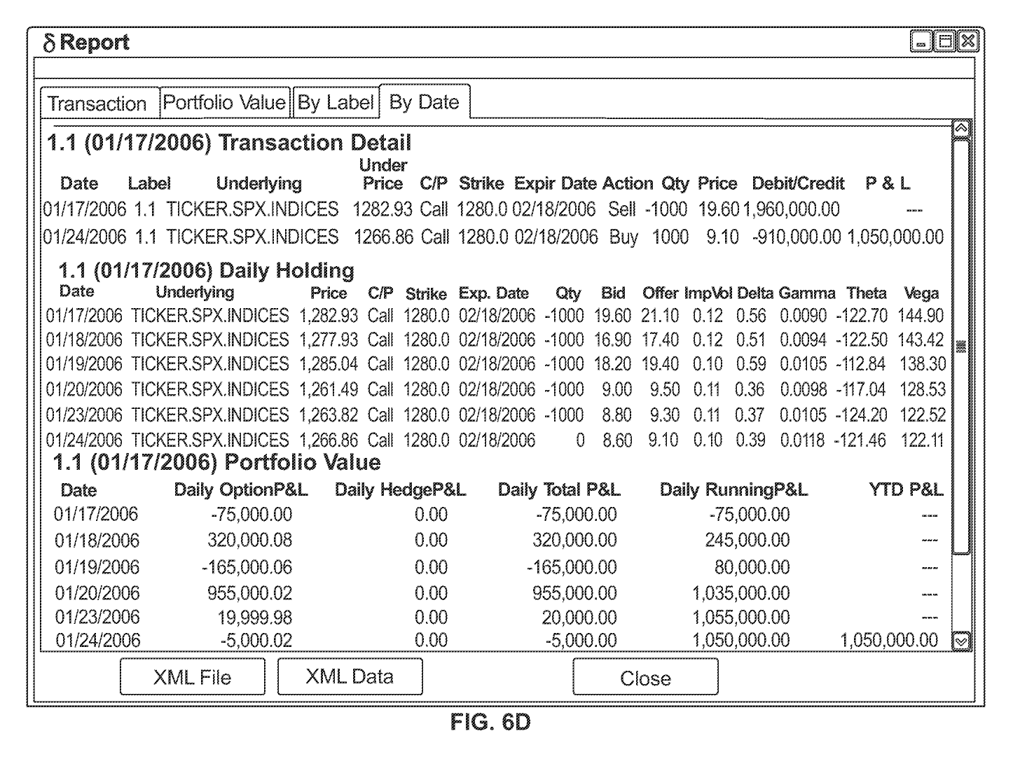

After a query is created and executed, the processor 28 will provide data to the reporting engine 32, which will create reports and send those reports to the user interface 16 (a screen or a printer). FIG. 6A-FIG. 6D show reports produced by the described embodiment depending on which tab is selected on the report window. FIG. 6A shows a report displaying overall transaction detail, which appears form selecting the Transaction tab. FIG. 6B shows a report displaying overall portfolio value, which appears from selecting the Portfolio Value tab. FIG. 6C shows a report displaying transactions by labeled trade, which appears from selecting the By Label tab. FIG. 6D shows a report displaying transaction detail by date, which appears from selecting the By Date tab.

As an example of creating a delta hedge with the user interface 16, it will now be shown how to create a buy order with a straddle, how to create a custom event, and how to add a delta hedge. Specifically, this example will show an order to buy 1000 at the money second month straddles in Goldman Sachs (GS) when the ratio of GS second month implied volatility divided by Lehman Brothers (LEH) second month implied volatility is less than or equal to 0.8; delta hedge this strategy every day the position exceeds 10000. The query will appear as:

```
1: OPTION_ORDER
      1.1: Buy 1000 ATM prompt 1 Straddle of equity
      TICKER.GS.NYSE
      Delta Hedge with Close every 1 Day position exceeds 10000.0
WHEN
      CALL.ITM_001_PROMPT_001_ImpVol of GS_OPTREL /
      CALL.ITM_001_PROMPT_001_ImpVol of LEH_OPTREL is
      less than 0.8
AND
      Date is after 1/1/2004
```

First, create a buy order for the 1000 ATM second month straddles in GS. Begin by entering the Option Order. In the Contract Quantity pane, select Buy and enter 1000 for the quantity. In the Money pane, select ATM. In the Contract pane, select Prompt: 1 which indicates the second month. In the Option pane, select Straddle in the Strategy drop-down menu. Select the ticker symbol by clicking the Search Database button and navigating to TICKER.GS.NYSE

(Equities>Ticker>Ticker_G>Ticker_GS>TICKER.GS.NYSE). Right-click and choose Select and Close.

For the second step, delta hedge this strategy by selecting the Delta Hedge check box. Then, select 1 Day and enter 10000 for the value of when the position exceeds.

For the third step, create the first part of the WHEN condition by selecting the Condition button and choosing Custom Event. Search for the GS second month Implied Volatility by clicking the Search Database button. Navigate to the symbol GS_OPTREL by selecting the Tree View tab, then open the folders

(Options>OptionMetrics>EquitiesOptionsRelative>g>gs>GS_OPTREL). Expand the symbol and select CALL.ITM_{—}001_PROMPT_{—}001_ImpVol. Right-click and choose Select and Close.

For the fourth step, in order to add the division symbol, click the Arithmetic Operator button. Select the Divide radio button. The SHOW pane becomes activated. Enter the other half of the division equation by entering the symbol or searching using the Search Database button. Navigate to the symbol LEH_OPTREL by selecting the Tree View tab, then open the folders

(Options>OptionMetrics>EquitiesOptionsRelative>l>le>LEH_OPTREL). Select CALL.ITM_{—}001_PROMPT_{—}001_ImpVol. Right-click and choose Select and Close. Click the Add Attribute to Query button. Click Continue. The Conditional Operator pane is activated.

For the fifth step, select the first conditional operator. Change “is exactly” to “is less than” by selecting the appropriate drop-down list. Click Continue. The Right Attribute pane is activated.

For the sixth step, select the Down Arrow button and change the selection from Symbol to Constant. Enter 0.8 and click OK to create the custom event.

For the seventh step, the final part of the WHEN statement is an AND Date Time Condition. In the When pane, select then click the Condition button and select Date Time Condition.

For the eighth step, in the Date Time Condition window, select the Date or Time button and select Date is after. Change the condition by clicking it and selecting. Enter the date 1/1/2004 and select OK.

For the final step, select the Report button to generate reports listing the Overall Transaction Detail and Portfolio Value.

As an example of creating treasury futures strangles, it will now be shown how to search for futures contracts, how to create a Date Time condition, how to work with continuous contracts, and how to manually edit the syntax. Specifically, this example will show an order to sell 250 OTM March ten-year treasury futures strangles seven days before the FOMC meets on interest rates, holding this position until expiration. The query will appear as:

```
1: OPTION_ORDER
      1.1: Sell 500 1 OTM Straddle of future TY_H
WHEN
      Date is 7 days before in “USA_FOMC_Rate_Meeting”
AND
      Date is after 1/1/2000
AND
      Date is first quarter
```

First, create a sell order for the 500 OTM straddles for the continuous March Ten Year Treasury Futures (TY_H). Begin by entering the Option Order. In the Contract Quantity pane, select Sell and enter 500 for the quantity. In the Money pane, select OTM. In the Option pane, select Straddle in the Strategy drop-down menu. To select the continuous TY_H contract, one must select the TY2000_H contract then delete the year by manually editing the query. Begin by clicking the Search Database button. In the Search Options window, select Futures. Scroll down and select TY. The individual contracts are listed in the right column. Scroll down and double-click TY_{—}2000H.

Second, the Sell trade is added to the Options Order window. To change the trade to reflect the continuous TY_H contract, change TY_{—}2000H to TY_H by manually editing the query to delete “2000”.

Third, create the first part of the WHEN condition by clicking Condition>Date Time Condition. Click the Date or Time button and select Date is. Select the Time Offset button. Enter 7 Days Before. Click OK. The Date Time Condition window is updated as shown below.

Fourth, click the button and select In File>server file. Then, click Browse and in the Date Events window, navigate to

Monetary>UnitedStates>FOMC>USA_FOMC_Rate_Meeting. Click OK to select this date event. Click OK in the Date Events window to add this to the Options Order window.

Fifth, the next part of the WHEN statement is an AND Date Time Condition. In the When pane, select then click the Condition button and select Date Time Condition.

Sixth, in the Date Time Condition window, select the button and select Date is after. Change the condition by clicking it and selecting. Enter the date 1/1/2000 and select OK.

Seventh, the final part of the WHEN statement is another AND Date Time Condition. In the When pane, select then click the Condition button and select Date Time Condition.

Eighth, in the Date Time Condition window, select the button and select Date is. Change the condition by clicking it and selecting in quarter>first quarter. Select OK.

Finally, select the Report button to generate a Transaction Detail Report.

As an example of delta calls, it will now be shown how to work with delta calls, how to create studies, how to add custom events, and how to manually edit the syntax. Specifically, this example will show an order to buy 200 Natural Gas third month 10 delta calls when the front month volatility of NG makes a 52 week low and exit the strategy 30 days later. The query will appear as:

```
1: OPTION_ORDER
      1.1: Buy 200 {gt(delta,0.10)} prompt 2 Call of future NG
WHEN
      Date is after 1/1/1996
AND
      Imp Vol of NG is at most 52 week lowest of Imp Vol of NG
EXIT
      Date is 30 days after entry
```

First, create a buy order for the 200 Natural Gas third month 10 delta calls. Begin by entering the Option Order. In the Contract Quantity pane, select Buy and enter 200 for the quantity. In the Contract pane, enter Prompt: 2. In the Option pane, select Call in the Strategy drop-down menu. To select the NG future, begin by clicking the Search Database button. In the Search Options window, select Futures. Scroll down and select NG. The individual contracts are listed in the right column. Double-click NG.

Second, the Buy trade is added to the Options Order window. To change the moneyness to reflect the delta call, change 1 ITM to {gt(delta,0.10)} by manually editing the query.

Third, create the first part of the WHEN condition by clicking Condition>Date Time Condition. In the Date Time Condition window, select the Date or Time button and select Date is after. Change the condition by clicking it and selecting. Enter the date 1/1/1996 and select OK.

Fourth, the next part of the WHEN statement is an AND condition referring to when the implied volatility of NG makes a 52 week low. In the When pane, select then click the Condition button and select Custom Event. In the Left Attribute pane, click the Search Database button to navigate to the ImpVol of NG (Futures>Nymex>NG>ImpVol) and right-click and choose Select and Close. Click Continue.

Fifth, in the Conditional Operator pane, select the first option and change the drop-down fields to is at most. Click Continue.

Sixth, in the Right Attribute pane, click the Studies button and select lowest. Click OK.

Seventh, in the Study: lowest window, click Attribute and click the Search Database button to navigate to the ImpVol of NG (Futures>Nymex>NG>ImpVol) and right-click and choose Select and Close. Click the Add Attribute to Query button. The Attribute button becomes red to indicate that the Series attribute is defined.

Eighth, click the Time Period button. In the first option, enter 52 weeks and click OK. The Time Period button becomes red. Click OK to accept the study.

Ninth, in the Custom Event window, the Studies button now has a red background to indicate a study has been defined. Click OK to enter the custom event.

Tenth, the final part of this query is to define an Exit condition. In the Exit pane, select the check box in this pane and enter 30 to set an exit condition 30 days after entry.

Finally, select the Report button to generate a Transaction Detail Report.

As an example of a covered strategy with custom roll, it will now be shown how to create a covered strategy, how to create a custom roll for the entire order, and how to work with deltas. Specifically, this example will illustrate the simulation of executing a covered call strategy with a customized option position roll based on the change in the options delta, and the number of days to expiration. The query will appear as:

```
1: OPTION_ORDER
      1.1: Sell 10 {lt(delta,0.3)} prompt 1 Call of equity
            TICKER.IWM.ARCA COVER 100% shares
      ROLL ORDER IF {max( delta ) <= −0.7 } or
            {min( delta ) >= −0.1 } or
            {max( daysexp ) <= 3 }
      WHEN
            Date is 12/3/2007
```

First, create a sell order for 10 IWM 0.30 delta calls in the second month. In this example with start date of 12/3/2007, these will be January IWM calls. Begin by entering the Option Order. In the Contract Quantity pane, select Sell and enter 10 for the quantity. Select the Function tab. In the appropriate drop-down boxes, select delta, lt, 0.3. In the Contract pane, select Prompt: 1 which indicates the second month. In the Option pane, select Call in the Strategy drop-down menu. Select the ticker symbol by clicking the Search Database button and navigating to

TICKER.IWM.ARCA(Equities>Ticker>Ticker_I>Ticker_IW>TICKER.IWM.ARCA). Right-click and choose Select and Close. In the Cover pane, select % Shares: 100.

Second, set the conditions to roll the entire order if the maximum value of the delta is less than or equal to −0.7 or the minimum value of the delta is greater than or equal to −0.1 or the days to expiration is less than or equal to 3. The numeric value entered for the option roll criteria must reflect the delta of the option position. In this example, selling a 0.30 delta call, if the upside threshold of the options delta is 0.70, then the value must be entered as −0.70. Begin by selecting the Add Roll Order If button. The Roll IF window displays.

Third, in the Roll Order If pane, select the Expr2 button to define the first part of the condition. Then, select Property Func. In the appropriate drop-down boxes, select max, delta, <=. Select the Expr3 button to define the value for the condition. Choose Value and enter the value −0.7.

Fourth, select the Add Another Condition button. Change the connection from AND to OR in the dropdown list.

Fifth, repeat the procedure in Step 3 for using the values min, delta, >=. Select the Expr5 button to define the value for the condition. Choose Value and enter the value −0.1. Select the Add Another Condition button. Change the connection from AND to OR in the drop-down list.

Sixth, select the Expr6 button and click Property Func. In the appropriate drop-down boxes, select max, daysexp, <=. Select the Expr7 button to define the value for the condition as 3.

Seventh, select OK to add the Roll Order If criteria to the Option Order.

Eighth, set the WHEN condition by clicking the Condition button in the When pane and selecting Date Time Condition.

Ninth, in the Date Time Condition window, select the Date or Time button and select Date is. Change the condition by clicking it and selecting. Enter the date 12/3/2007 and select OK.

Finally, select the Report button to generate reports on Transaction Detail and Portfolio Value.

As an example of CBOE Put Call Index it will now be shown how to use value in percent, how to create studies, and how to add custom events. Specifically, this example will show a spread when the CBOE put call index is greater than 1.1 (1.1 puts traded for each call traded). The query will appear as:

```
1: OPTION_ORDER
      1.1: Buy 1000 ATM prompt 1 Call of index
      TICKER.SPX.INDICES
      1.2: Sell 1000 3 % OTM prompt 1 Call of index
      TICKER.SPX.INDICES
WHEN
      PutVol of CBO.ALL / CallVol of CBO.ALL is more than 1.1
AND
      Date is after 1/1/1996
```

As an example of a seasonal December NG option trade, use the following query:

```
1: OPTION_ORDER
      1.1: Sell 500 {gt(delta,0.5)} Call of future NG_Z
      1.2: Buy 500 {gt(delta,0.1)} Call of future NG_Z
WHEN
      LowTemperature of LAX.CA.ESAT.CLEAN is more than
            Forward_CD0 of
      LAX.CA.ESAT.FCASTLOW
AND
      GasStorage of EIA.TOTAL.US is more than GasStorage of
            EIA.TOTAL.US 1
      week ago
AND
      Date is third quarter
AND
      Date is after 2000
```

As an example of a heating oil crack spread, the following query shows an option order when the ratio of Heating Oil divided by Crude crosses 1.25, buy 500 second month At the Money OIH (Oil Industry Holders Trust) calls and 500 second month At the Money crude calls:

```
1: OPTION_ORDER
      1.1: Buy 500 ATM prompt 1 Call of index TICKER.OIH.MKT
      1.2: Buy 500 ATM prompt 1 Call of future CL
WHEN
      ((HO * 0.42) / Close of CL) crosses above 1.25
AND
      Date is after 1996
```

As an example of a realized volatility strategy, the following query shows how to enter and exit a strategy based on fluctuations in different term historical or realized volatility of the underlying security. In this example, compare the movements of the 21 day historical volatility versus the 252 day historical volatility of the S&P500 future:

```
1: OPTION_ORDER
      1.1: Buy 1000 {le(delta,0.5)} prompt 1 Call of index
            TICKER.SPX.INDICES
      1.2: Sell 1000 {le(delta,0.25)} prompt 1 Call of index
            TICKER.SPX.INDICES
WHEN
      (21 day std_dev of natural_log ( Close of SP / Close of SP 1 value
      ago ) * (252 ** 0.5)) crosses above (252 day std_dev of
      natural_log ( Close of SP / Close of SP 1 value ago ) *
      (252 ** 0.5)) + 0.1
AND
      Date is after 12/1/2000
AND
      SPX is DEFINED
EXIT
      Date is after 12/2/2000
AND
      (21 day std_dev of natural_log ( Close of SP / Close of SP 1 value
      ago ) * (252 ** 0.5)) crosses below (252 day std_dev of
      natural_log ( Close of SP / Close of SP 1 value ago ) *
      (252 ** 0.5)) + 0.1
```

While the present inventions have been illustrated by a description of various embodiments and while these embodiments have been set forth in considerable detail, it is intended that the scope of the inventions be defined by the appended claims. It will be appreciated by those skilled in the art that modifications to the foregoing preferred embodiments may be made in various aspects. It is deemed that the spirit and scope of the inventions encompass such variations to be preferred embodiments as would be apparent to one of ordinary skill in the art and familiar with the teachings of the present application.

What is claimed is:

1. A computer-implemented programmed machine that enables a user to simulate the execution of derivative trading strategies, comprising:
a first dataset containing historical daily price information about tradable securities;
a second dataset containing historical daily information for a plurality of derivatives of each underlying tradable security, wherein the derivatives are financial contracts, or financial instruments, whose values are derived from the value of something else, known as the underlying;
a third dataset containing derivative relative data created from historical daily information for said securities and said derivatives and stored as a continuous historical series, wherein said derivative relative dataset is derived from each derivative's relative position to the underlying with respect to price and date information;
a market information database comprising said first dataset, said second dataset, and said third dataset;
a user interface that facilitates gathering information from the user defining a desired derivative trading strategy with respect to one or more of the tradable securities;
a machine-parsable expression generator that states precisely the user's desired derivative trading strategy;
a parser that parses the machine-parsable expression into a sequence of commands;
a processor that executes responsive to the parser to extract data from the database;
a trading execution engine responsive to the processor that receives data from the database and computes the simulated trading position that would have resulted from actual execution of the derivative trading strategy in the historical timeframe; and
a reporting engine that allows the user to visualize the results of the computations as reports that express the results of the simulated execution of the derivative trading strategy that would have resulted from actual execution of the derivative trading strategy in the historical timeframe, including the daily profits and losses.

2. The machine recited in claim 1 wherein said market information database further comprises, with respect to each tradable security, historical daily information about options corresponding to the tradable security including the option's strike price, expiration date, its daily position in or out of or at the money, known as moneyness, its closing bid and ask prices, and one or more of its daily greek values, including delta values.

3. The machine recited in claim 1 wherein the market information database further comprises a model based pricing dataset containing simulated historical information wherein said dataset supplements the market information database.

4. The machine recited in claim 2 wherein the market information database further comprises an option relative dataset for creating continuous option contracts for historical reference by an option's position to the underlying by relative moneyness.

5. The machine recited in claim 2 wherein the market information database further comprises an option relative dataset for creating continuous option contracts for historical reference by an option's term to expiration.

6. The machine recited in claim 4 wherein the market information database further comprises option greeks and market statistics converted into continuous historical series.

7. The machine recited in claim 5 wherein the market information database further comprises option greeks and market statistics converted into continuous historical series.

8. The machine recited in claim 1 wherein the user interface further comprises:
an enter and edit query pane for entering one or more trades directly, by selecting elements, or by a command line where the user can navigate between trades;
an option order pane for entering the trade type, the contract quantity, the moneyness, a delta value, the month of the contract relative to the option's expiration, the option strategy, the option to order, the percentage of shares to cover, and the conditions under which to roll the trade;
a hedge pane for setting conditions of the delta hedge based on time period and value of a position;
a roll-order-if pane for setting conditions under which to roll the option order;
a when pane for defining the conditions under which the option order should be executed; and
an exit pane for defining the criteria under which to exit the option position.

9. The machine recited in claim 1 wherein the machine-parsable expression generator generates user input into an ORDER-WHEN-EXIT formatted query.

10. The machine recited in claim 1 wherein the user interface further comprises a report manipulation pane for manipulating the dates and price adjustment status of the data shown.

11. The machine recited in claim 10 wherein the report manipulation pane further comprises a user input for selecting whether the reporting engine will produce reports showing five day series or seven day series.

12. The machine recited in claim 10 wherein the report manipulation pane further comprises a user input for selecting whether the reporting engine will produce reports showing derivative trading strategy position data for every day or only for days when data changes.

13. The machine recited in claim 10 wherein the report manipulation pane further comprises a user input for selecting whether the reporting engine will produce reports showing overlapping time periods as the union of the two periods or as the intersection of the two periods.

14. The machine recited in claim 10 wherein the report manipulation pane further comprises a user input for selecting whether the reporting engine will produce reports showing backward adjusted pricing data.

15. The machine recited in claim 11 wherein the reporting engine is responsive to a user input that allows the user the visualize reports showing five day series or seven day series.

16. The machine recited in claim 12 wherein the reporting engine is responsive to a user input that allows the user the visualize reports showing derivative trading strategy position data for every day or only for days when data changes.

17. The machine recited in claim 13 wherein the reporting engine is responsive to a user input that allows the user the visualize reports showing overlapping time periods as the union of the two periods or as the intersection of the two periods.

18. The machine recited in claim 14 wherein the reporting engine is responsive to a user input that allows the user the visualize reports showing backward adjusted pricing.

19. A method for simulating the execution of derivative trading strategies with a computer-implemented programmed machine comprising:
providing a first dataset containing historical daily price information about tradable securities;
providing a second dataset containing historical daily information for a plurality of derivatives of each underlying tradable security, wherein the derivatives are financial contracts, or financial instruments, whose values are derived from the value of something else, known as the underlying;
providing a third dataset containing derivative relative data created from historical daily information for said securities and said derivatives and stored as a continuous historical series, wherein said derivative relative dataset is derived from each derivative's relative position to the underlying with respect to price and date information;
providing a market information database comprising said first dataset, said second dataset, and said third dataset;
providing a user interface that facilitates gathering information from the user defining a desired derivative trading strategy with respect to one or more of the tradable securities;
providing a machine-parsable expression generator that states precisely the user's desired derivative trading strategy;
parsing the machine-parsable expression into a sequence of commands;
providing a processor that executes responsive to the parser to extract data from the database;
providing a trading execution engine responsive to the parser that receives data from the database and computes the simulated trading position that would have resulted from actual execution of the derivative trading strategy in the historical timeframe; and
providing a reporting engine that allows the user to visualize the results of the computations as reports that express the results of the simulated execution of the derivative trading strategy that would have resulted from actual execution of the derivative trading strategy in the historical timeframe, including the daily profits and losses.

20. The method for simulating the execution of derivative trading strategies recited in claim 19 further comprising:
entering a query representing one or more trades by selecting elements or by a command line;
entering the trade type, the contract quantity, the moneyness, a delta value, the month of the contract relative to the option's expiration, the option strategy, the option to order, the percentage of shares to cover, and the conditions under which to roll the trade;
setting conditions of the delta hedge based on time period and value of position;
setting conditions under which to roll the option order;
defining the conditions under which the option order should execute;
defining the criteria under which to exit the option position;
defining the criteria for generating reports based on the simulated trade;
executing the simulated trade; and
viewing reports of the simulated trade.
